(19) United States
(12) Patent Application Publication
(10) Pub. No.: US 2016/0259120 A1
(43) Pub. Date: Sep. 8, 2016

(54) LIQUID CRYSTAL DISPLAY DEVICE AND BACKLIGHT MODULE THEREOF

(71) Applicant: Shenzhen China Star Optoelectronics Technology Co., Ltd., Shenzhen City, Guangming (CN)

(72) Inventors: Yu-chun HSIAO, Shenzhen, Guangdong (CN); Chengwen QUE, Shenzhen, Guangdong (CN)

(73) Assignee: Shenzhen China Star Optoelectronics Technology Co., Ltd., Shenzhen, Guangdong (CN)

(21) Appl. No.: 14/406,214

(22) PCT Filed: Oct. 28, 2014
(86) PCT No.: PCT/CN2014/089709

§ 371 Date: Dec. 6, 2014

(30) Foreign Application Priority Data
Oct. 22, 2014 (CN) 201410568473.1

(51) Int. Cl. F21V 8/00; G02F 1/1333

(52) U.S. Cl. CPC G02B 6/0088; G02F 1/133308; G02F 2001/13332

(57) ABSTRACT

A liquid crystal display device and a backlight module are provided. An optical film set of the backlight module includes at least one lug portion including an inverted hook portion and an extension portion which as an entirety extend from an edge of the optical film set toward a plastic frame. The plastic frame has first and second supporting portions extending toward a light guide plate. The first supporting portion is disposed with an accommodating groove and a blocking portion. The second supporting portion is for supporting a display panel abutted with the first supporting portion. The blocking portion is formed with a first notch communicated with the accommodating groove, the extension portion is passed through the first notch and the inverted hook portion is accommodated into the accommodating groove. The blocking portion blocks the inverted hook portion to move toward the light guide plate.

### TECHNICAL FIELD

The present invention relates to the field of liquid crystal display technology, and particularly to a liquid crystal display device and a backlight module thereof, so as to achieve the positioning of optical film set in the slim design.

### DESCRIPTION OF RELATED ART

A backlight module for liquid crystal display device primarily includes a light source, a plastic frame, a back plate, a light guide plate and an optical film set. The light guide plate is disposed on a bottom surface of the plastic frame facing toward the back plate, the optical film set is disposed on a top surface of the plastic frame, the light guide plate is for converting a point light source into a surface light source for display, and the optical film set is for uniformizing light rays and increasing the display brightness.

The optical film set is very soft and brittle, in order to prevent the optical film set from being damaged caused by dislocation or escape during assembling and transporting, the top-mounted structure as shown in FIG. 1 and the bottom-mounted structure as shown in FIG. 2 are commonly used for the positioning of optical film set in the industry. As shown in FIG. 1, the optical film set 11 is positioned by engaging a lug portion 111 of the optical film set 11 with a hook 121 fixed on the back plate 12. As shown in FIG. 2, the optical film set 21 is positioned by engaging a lug portion 211 of the optical film set 21 with a hook 221 disposed on the plastic frame 22. However, since an extension portion of the plastic frame for supporting a display panel and the optical film set are disposed in up-and-down relationship, on the thickness direction of the liquid crystal display device, it is inevitable that there is an existence of thickness T of the extension portion of the plastic frame, which is unfavourable for the slim design of the liquid crystal display device.

### SUMMARY

Accordingly, a technical problem desired to be solved by the present invention is to provide a liquid crystal display device and a backlight module thereof, which is in favor of the slim design of liquid crystal display device while achieves the positioning of optical film set.

In order to solve the above technical problem, a technical solution proposed by the present invention is to provide a backlight module. The backlight module includes a light source, a back plate, and a light guide plate, a plastic frame and an optical film set sequentially disposed above the back plate in that order. The optical film set includes at least one lug portion. The lug portion includes an inverted hook portion and an extension portion connected with the inverted hook portion which extend from an edge of the optical film set toward the plastic frame. The plastic frame has connected first supporting portion and second supporting portion which extend toward the light guide plate. The first supporting portion is disposed with an accommodating groove and a blocking portion. The second supporting portion is configured (i.e., structured and arranged) for supporting a display panel and making the display panel be abutted with the first supporting portion. A bottom surface of the accommodating groove is higher than a plane where a main body of the optical film set is located and thereby the inverted hook portion and the extension portion have an intersection angle existed therebetween and being not equal to zero. The blocking portion is formed with a first notch communicated with the accommodating groove. The extension portion is passed through the first notch, and the inverted hook portion is accommodated into the accommodating groove. The blocking portion is configured for blocking the inverted hook portion to move toward the light guide plate. The blocking portion comprises oppositely-disposed two stopping blocks between which the first notch is formed. The blocking portion and the plastic frame are integrally formed. The backlight module further includes a press holding plate, and the press holding plate press-holds the inverted hook portion in the accommodating groove.

In an exemplary embodiment, the edge of the optical film set is abutted with the second supporting portion.

In an exemplary embodiment, the extension portion includes connected first extension part and second extension part. The first extension part is connected with the inverted hook portion, and the second extension part is connected with the edge of the optical film set. The second extension part and the main body of the optical film set are located on a same plane.

In an exemplary embodiment, the second supporting portion is disposed with a second notch. The second notch is communicated with the first notch and the accommodating groove. The second extension part is passed through the second notch.

In an exemplary embodiment, the edge of the optical film set is abutted with the first supporting portion.

In order to solve the above technical problem, another technical solution proposed by the present invention is to provide a backlight module. The backlight module includes a light source, a back plate, and a light guide plate, a plastic frame and an optical film set sequentially disposed above the back plate in that order. The plastic frame has connected first supporting portion and second supporting portion which extend toward the light guide plate. The first supporting portion is disposed with an accommodating groove and a blocking portion. The second supporting portion is configured for supporting a display panel and making the display panel be abutted with the first supporting portion. The blocking portion is formed with a first notch communicated with the accommodating groove. The extension portion is passed through the first notch, and the inverted hook portion is accommodated into the accommodating groove. The blocking portion is configured for blocking the inverted hook portion to move toward the light guide plate.

In an exemplary embodiment, the backlight module further includes a press holding plate, and the press holding plate press-holds the inverted hook portion in the accommodating groove.

In an exemplary embodiment, a bottom surface of the accommodating groove is higher than a plane where a main body of the optical film set is located and thereby a non-zero intersection angle is existed between the inverted hook portion and the extension portion.

In an exemplary embodiment, the edge of the optical film set is abutted with the second supporting portion.

In an exemplary embodiment, the extension portion includes connected first extension part and second extension part. The first extension part is connected with the inverted hook portion, and the second extension part is connected with the edge of the optical film set. The second extension part and the main body of the optical film set are located on a same plane.

In an exemplary embodiment, the second supporting portion is disposed with a second notch. The second notch is communicated with the first notch and the accommodating groove. The second extension part is passed through the second notch.

In an exemplary embodiment, the edge of the optical film set is abutted with the first supporting portion.

In an exemplary embodiment, the blocking portion includes oppositely-disposed two stopping blocks between which the first notch is formed. The blocking portion and the plastic frame are integrally formed.

In an exemplary embodiment, the lug portion is T-shaped along a direction perpendicular to the light guide plate and facing toward the back plate.

In order to solve the above technical problem, still another technical solution proposed by the present invention is to provide a liquid crystal display device. The liquid crystal display device includes a front frame, a display panel and a backlight module. The backlight module includes a light source, a back plate, and a light guide plate, a plastic frame and an optical film set sequentially disposed above the back plate. The optical film set includes at least one lug portion. The lug portion includes an inverted hook portion and an extension portion connected with the inverted hook portion which as an entirety extend from an edge of the optical film set toward the plastic frame. The plastic frame has connected first supporting portion and second supporting portion which extend toward the light guide plate. The first supporting portion is disposed with an accommodating groove and a blocking portion. The second supporting portion is configured for supporting the display panel and making the display panel be abutted with the first supporting portion. The blocking portion is formed with a first notch communicated with the accommodating groove. The extension portion is passed through the first notch, and the inverted hook portion is accommodated into the accommodating groove. The blocking portion is configured for blocking the inverted hook portion to move toward the light guide plate.

In an exemplary embodiment, the backlight module further includes a press holding plate, and the press holding plate press-holds the inverted hook portion in the accommodating groove.

In an exemplary embodiment, a bottom surface of the accommodating groove is higher than a plane where a main body of the optical film set is located and thereby the inverted hook portion and the extension portion have an intersection angle formed therebetween and being not equal to zero.

In an exemplary embodiment, the blocking portion includes oppositely-disposed two stopping blocks between which the first notch is formed. The blocking portion and the plastic frame are integrally formed.

In an exemplary embodiment, the lug portion is T-shaped along a direction perpendicular to the light guide plate and facing toward the back plate.

By adopting the above technical solutions, beneficial effects can be achieved by the present invention are that: in the embodiments of the present invention, the inverted hook portion and the extension portion of the at least one lug portion of the optical film set are engaged with the accommodating groove and the blocking portion on the first supporting portion of the plastic frame, the extension portion is passed through the first notch, the inverted hook portion is accommodated into the accommodating groove, and the blocking portion blocks the inverted hook portion to move toward the light guide plate, so that the dislocation of the optical film set during assembling and transporting can be prevented, and the positioning of the optical film set is achieved. Meanwhile, the second supporting portion is for supporting the display panel and making the display panel be abutted with the first supporting portion, the thickness of the portion of plastic frame for supporting the display panel, i.e., the first supporting portion is reduced, which is in favor of the slim design of backlight module and liquid crystal display device.

### BRIEF DESCRIPTION OF THE DRAWINGS

In order to more clearly illustrate the technical solutions of various embodiments of the present invention, drawings will be used in the description of embodiments will be given a brief description below. Apparently, the drawings in the following description only are some embodiments of the invention, the ordinary skill in the art can obtain other drawings according to these illustrated drawings without creative effort. In the drawings:

FIG. 1 is a schematic structural cross-sectional view of a backlight module according to a first embodiment of the related art;

FIG. 2 is a schematic structural cross-sectional view of a backlight module according to a second embodiment of the related art;

FIG. 3 is a schematic structural cross-sectional view of a backlight module according to a preferred embodiment of the present invention;

FIG. 4 is a schematic partially exploded view of the backlight module of FIG. 3;

FIG. 5 is a schematic view of positioning an optical film set of the backlight module of FIG. 3; and

FIG. 6 is a schematic structural cross-sectional view of a liquid crystal display device having the backlight module of FIG. 3.

### DETAILED DESCRIPTION OF EMBODIMENTS

In the following, with reference to accompanying drawings of embodiments of the present invention, technical solutions in the embodiments of the present invention will be clearly and completely described. Apparently, the embodiments of the present invention described below only are a part of embodiments of the present invention, but not all embodiments. Based on the described embodiments of the present invention, all other embodiments obtained by ordinary skill in the art without creative effort belong to the scope of protection of the present invention.

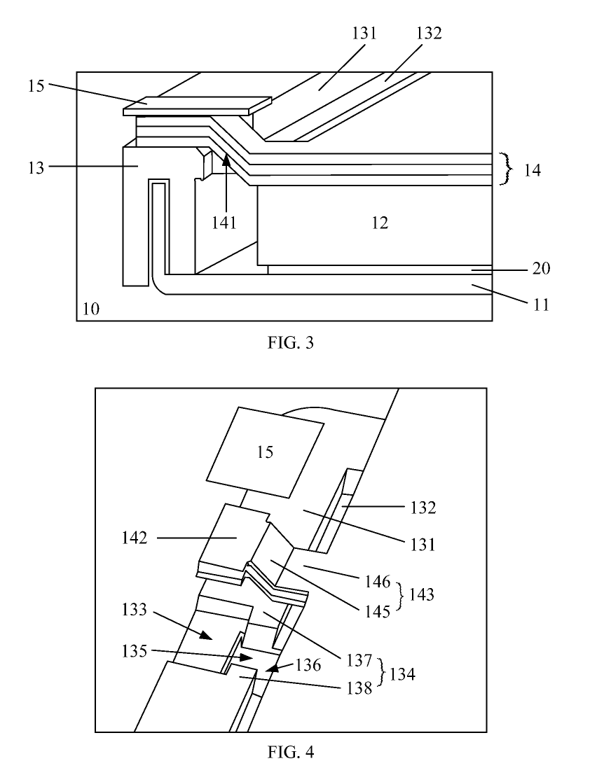

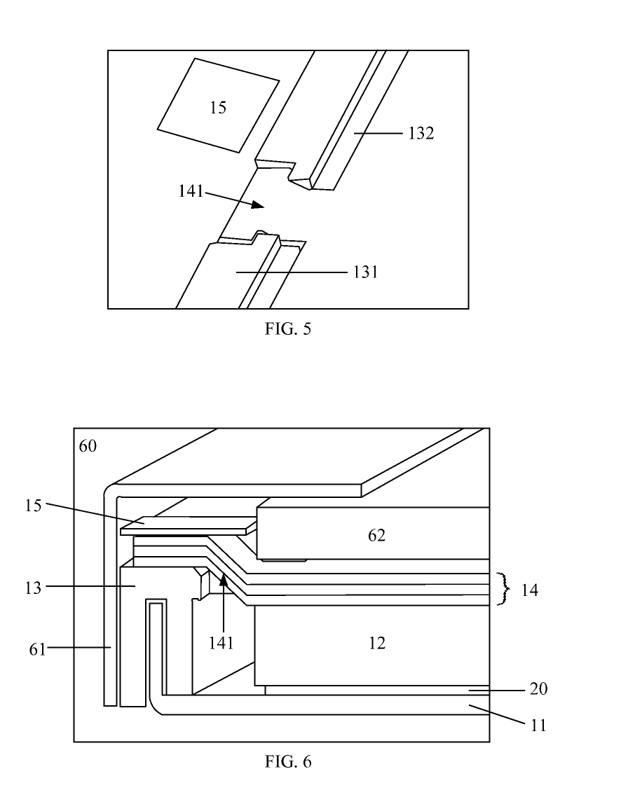

FIG. 3 is a schematic structural cross-sectional view of a backlight module according to a preferred embodiment of the present invention, FIG. 4 is a schematic partially exploded view of the backlight module of FIG. 3, and FIG. 5 is a schematic view of positioning an optical film set of the backlight module of FIG. 3. Referring to FIG. 3 through FIG. 5 together, the backlight module 10 in the illustrated embodiment at least includes a back plate 11, and a reflective sheet 20, a light guide plate 12, a plastic frame 13 and an optical film set 14 sequentially disposed above the back plate 11 in that order.

The optical film set 14 is one or multiple (i.e., more than one) optical films capable of uniformizing light rays emitted from a light emergence surface of the light guide plate 12 and increasing the display brightness. The optical film set 14 in the illustrated embodiment includes at least one lug portion 141. The lug portion 141 includes an inverted hook portion 142 and an extension portion 143 which as an entirety extend from an edge of the optical film set 14, i.e., an edge of a main body of the optical film set, toward the plastic frame 13. The extension portion 143 is connected with the inverted hook portion 142.

The plastic frame 13 is disposed with a first supporting portion 131 and a second supporting portion 132 which extend along a direction toward the light guide plate 12. The first supporting portion 131 and the second supporting portion 132 are connected with each other and a top surface of the first supporting portion 131 is higher than a top surface of the second supporting portion 132. In addition, the top surface of the first supporting portion 131 is disposed with an accommodating groove 133 and a blocking portion 134, the second supporting portion 132 is configured (i.e., structured and arranged) for supporting a display panel of liquid crystal display device and making the display panel be abutted with the first supporting portion 131.

In the illustrated embodiment of the present invention, the blocking portion 134 is formed with a first notch 135 communicated with the accommodating groove 133, the extension portion 143 is passed through the first notch 135, and the inverted hook portion 142 is accommodated into the accommodating groove 133, and at this time the blocking portion 134 blocks the inverted hook portion 142 to move toward the light guide plate, and thereby achieves the positioning of the whole optical film set 14. As a result, the occurrence of dislocation of the optical film set 14 during assembling and transporting can be prevented.

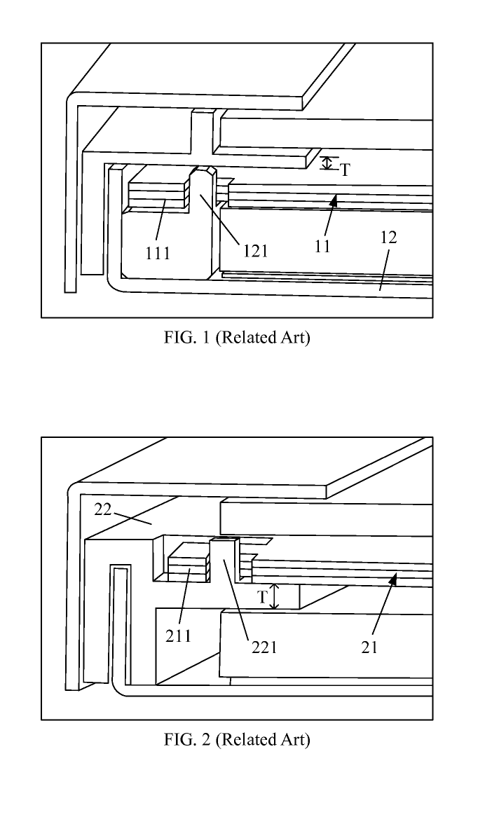

Compared with the backlight modules of the related art as shown in FIG. 1 and FIG. 2, the backlight module 10 in the illustrated embodiment of the present invention, due to the disposition of the first supporting portion 131 and the second supporting portion 132, makes the display panel be abutted with the first supporting portion 131 while the display panel is supported, a thickness of the portion (first supporting portion 131) of the plastic frame 13 for supporting the display panel is reduced, and therefore is in favor of the slim design.

Referring to FIG. 3 through FIG. 5 again, the backlight module 10 in the illustrated embodiment of the present invention further includes a press holding plate 15. The press holding plate 15 is used to press-hold the inverted hook portion 142 of the lug portion 141 of the optical film set 14 in the accommodating groove 133, which can prevent the escape of the optical film set 14 during assembling and transporting, and thereby further achieves the positioning of the whole optical film set 14. In a preferred embodiment, the press holding plate 15 is a rectangular plate-shaped structure, so as to reduce the occupying space in the backlight module 10.

Moreover, when the characteristics of supporting the display panel of liquid crystal display device and maintaining the structure itself are taken in account, the plastic frame 13 requires the first supporting portion 131 and the second supporting portion 132 each to have a certain thickness, and the depth of the accommodating groove 133 being set to be equal to or approximate to the thickness of the optical film set 14 makes the bottom surface of the accommodating groove 133 be higher than a plane where the main body of the optical film set 14 is located and results in a non-zero intersection angle formed between planes where the inverted hook portion 142 and the extension portion 143 respectively are located. Therefore, in a preferred embodiment of the present invention, the extension portion 143 and each of the planes where the main body of the optical film set 14 and the inverted hook portion 142 respectively are located have a same intersection angle formed therebetween, i.e., the extension portion 143 is at least partially inclined.

In addition, in a preferred embodiment, the edge of the optical film set 14 is abutted with the second supporting portion 132, and based on this, the extension portion 143 of the optical film set 14 includes a first extensions part 145 and a second extension part 146 connected with each other. The first extension part 145 is connected with the inverted hook portion 142. The second extension part 146 is connected with the edge of the main body of the optical film set 14, and the second extension part 146 and the main body of the optical film set 14 are located on a same plane. At this time, the plane where the first extension part 145 is located and each of the planes where the second extension part 146, the main body of the optical film set 14 and the inverted hook portion 142 respectively are located have a same intersection angle.

Correspondingly, the second supporting portion 132 of the plastic frame 13 is formed with a second notch 136, and the second notch 136 is communicated with the first notch 135 and the accommodating groove 133. Referring to FIG. 4 and FIG. 5 together, the second extension part 146 is passed through the second notch 136, when the display panel of a liquid crystal display device is supported on the second supporting portion 132, the side surface of the display panel would block the first extension part 145 to move along the direction toward the light guide plate 12, and thereby achieving the positioning of the optical film set 14.

It can be understood that, in other embodiment of the present invention, the edge of the optical film set 14 may be disposed to be abutted with the first supporting portion 131 instead, and at this situation, the second extension part 146 may be omitted, and thus the extension portion 143 only includes the first extension part 145. When the display panel of the liquid crystal display device is supported on the second supporting portion 132, the display panel press-holds the edge of the optical film set 14 on the second supporting portion 132, achieving the positioning of the optical film set 14.

Referring to FIG. 3, the backlight module 10 only is one embodiment of the present invention, for the blocking portion 134 of the backlight module 10 being disposed with two opposite stopping blocks 137, 138 b and the two stopping blocks 137, 138 having the first notch 135 formed therebetween, the other embodiment may have other design, the blocking portion 134 and the plastic frame 13 may be integrally formed or may not be integrally formed. Secondly, along the observation direction perpendicular to the light guide plate and facing toward the back plate 11, the lug portion 141 in the illustrated embodiment is T-shaped, and in other embodiment, the lug portion 141 may be triangle or other regular or irregular shape. In addition, for the engagement of accommodating structure in the backlight module 10, for example sizes such as thickness and height of the inverted hook portion 142 and the accommodating groove 133, or of the obliquely disposed first extension part 145 and the first supporting portion 131, or of the second extension part 146 and the second supporting portion 132 as well as the main body of the optical film set 14, ought to be the same or approximate to one another, so as to ensure the backlight module 10 to have a compact structure and further achieve the positioning of the optical film set 14.

The present invention also provides a liquid crystal display device 60 as shown in FIG. 6. The liquid crystal display device 60 includes a front frame 61, a display panel 62 and the backlight module (e.g., backlight module 10) of the above embodiment. The front frame 61 and the back plate (e.g., back plate 11) of the backlight module are fixedly engaged with each other, so as to firmly press-hold the display panel 62, the light guide plate (e.g., light guide plate 12) and the optical film set (e.g., optical film set 14) on the back plate. The liquid crystal display device 60 has the beneficial effects of the above backlight module 10.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A backlight module comprising a light source, a back plate, and a light guide plate, a plastic frame and an optical film set sequentially disposed above the back plate in that order; wherein
the optical film set comprises at least a lug portion, the lug portion comprises an inverted hook portion and an extension portion connected with the inverted hook portion which extend from an edge of the optical film set toward the plastic frame;
the plastic frame has connected first supporting portion and second supporting portion which extend toward the light guide plate, the first supporting portion is disposed with an accommodating groove and a blocking portion, the second supporting portion is configured for supporting a display panel and making the display panel be abutted with the first supporting portion, a bottom surface of the accommodating groove is higher than a plane where a main body of the optical film set is located and thereby the inverted hook portion and the extension portion have an intersection angle existed therebetween and being not equal to zero;
the blocking portion is formed with a first notch communicated with the accommodating groove, the extension portion is passed through the first notch, the inverted hook portion is accommodated into the accommodating groove, the blocking portion is configured for blocking the inverted hook portion to move toward the light guide plate, the blocking portion comprises oppositely-disposed two stopping blocks between which the first notch is formed, the blocking portion and the plastic frame are integrally formed;
the backlight module further comprises a press holding plate, and the press holding plate press-holds the inverted hook portion in the accommodating groove.

2. The backlight module as claimed in claim 1, wherein the edge of the optical film set is abutted with the second supporting portion.

3. The backlight module as claimed in claim 2, wherein the extension portion comprises connected first extension part and second extension part, the first extension part is connected with the inverted hook portion, the second extension part is connected with the edge of the optical film set, the second extension part and the main body of the optical film set are located on a same plane.

4. The backlight module as claimed in claim 3, wherein the second supporting portion is disposed with a second notch, the second notch is communicated with the first notch and the accommodating groove, the second extension part is passed through the second notch.

5. The backlight module as claimed in claim 1, wherein the edge of the optical film set is abutted with the first supporting portion.

6. A backlight module comprising a light source, a back plate, and a light guide plate, a plastic frame and an optical film set sequentially disposed above the back plate in that order; wherein
the optical film set comprises at least one lug portion, the lug portion comprises an inverted hook portion and an extension portion connected with the inverted hook portion which extend from an edge of the optical film set toward the plastic frame;
the plastic frame has connected first supporting portion and second supporting portion which extend toward the light guide plate, the first supporting portion is disposed with an accommodating groove and a blocking portion, the second supporting portion is configured for supporting a display panel and making the display panel be abutted with the first supporting portion;
the blocking portion is formed with a first notch communicated with the accommodating groove, the extension portion is passed through the first notch, the inverted hook portion is accommodated into the accommodating groove, and the blocking portion is configured for blocking the inverted hook portion to move toward the light guide plate.

7. The backlight as claimed in claim 6, wherein the backlight module further comprises a press holding plate, and the press holding plate press-holds the inverted hook portion in the accommodating groove.

8. The backlight module as claimed in claim 6, wherein a bottom surface of the accommodating groove is higher than a plane where a main body of the optical film set is located and thereby a non-zero intersection angle is existed between the inverted hook portion and the extension portion.

9. The backlight module as claimed in claim 8, wherein the edge of the optical film set is abutted with the second supporting portion.

10. The backlight module as claimed in claim 9, wherein the extension portion comprises connected first extension part and second extension part, the first extension part is connected with the inverted hook portion, the second extension part is connected with the edge of the optical film set, the second extension part and the main body of the optical film set are located on a same plane.

11. The backlight module as claimed in claim 10, wherein the second supporting portion is disposed with a second notch, the second notch is communicated with the first notch and the accommodating groove, the second extension part is passed through the second notch.

12. The backlight module as claimed in claim 8, wherein the edge of the optical film set is abutted with the first supporting portion.

13. The backlight module as claimed in claim 6, wherein the blocking portion comprises oppositely-disposed two stopping blocks between which the first notch is formed, the blocking portion and the plastic frame are integrally formed.

14. The backlight module as claimed in claim 6, wherein the lug portion is T-shaped along a direction perpendicular to the light guide plate and facing toward the back plate.

15. A liquid crystal display device comprising a front frame, a display panel and a backlight module; the backlight module comprising a light source, a back plate, and a light guide plate, a plastic frame and an optical film set sequentially disposed above the back plate; wherein
the optical film set comprises at least one lug portion, the lug portion comprises an inverted hook portion and an extension portion connected with the inverted hook portion which extend from an edge of the optical film set toward the plastic frame;
the plastic frame has connected first supporting portion and second supporting portion which extend toward the light guide plate, the first supporting portion is disposed with an accommodating groove and a blocking portion, the second supporting portion is configured for supporting the display panel and making the display panel be abutted with the first supporting portion;
the blocking portion is formed with a first notch communicated with the accommodating groove, the extension portion is passed through the first notch, the inverted hook portion is accommodated into the accommodating groove, the blocking portion is configured for blocking the inverted hook portion to move toward the light guide plate.

16. The liquid crystal display device as claimed in claim 15, wherein the backlight module further comprises a press holding plate, and the press holding plate press-holds the inverted hook portion in the accommodating groove.

17. The liquid crystal display device as claimed in claim 15, wherein a bottom surface of the accommodating groove is higher than a plane where a main body of the optical film set is located and thereby the inverted hook portion and the extension portion have an intersection angle formed therebetween and being not equal to zero.

18. The liquid crystal display device as claimed in claim 15, wherein the blocking portion comprises oppositely-disposed two stopping blocks between which the first notch is formed, the blocking portion and the plastic frame are integrally formed

19. The liquid crystal display device as claimed in claim 15, wherein the lug portion is T-shaped along a direction perpendicular to the light guide plate and facing toward the back plate.
